(19) United States
(12) Patent Application Publication
(10) Pub. No.: US 2023/0305695 A1
(43) Pub. Date: Sep. 28, 2023

(54) IMAGE FORMING APPARATUS, DISPLAY DEVICE, AND IMAGE FORMING APPARATUS CONTROL METHOD

(71) Applicant: SEIKO EPSON CORPORATION, TOKYO (JP)

(72) Inventor: Hiroki HIRATA, Matsumoto-shi (JP)

(21) Appl. No.: 18/188,502

(22) Filed: Mar. 23, 2023

(30) Foreign Application Priority Data
Mar. 23, 2022 (JP) 2022-047182

(51) Int. Cl. G06F 3/0488; G06F 3/041

(52) U.S. Cl. CPC G06F 3/0488; G06F 3/0416

(57) ABSTRACT

An image forming apparatus includes a touch panel that displays an operation screen, a region identification unit that identifies a contact region that is a region where a finger of a user operating the touch panel touches the touch panel, a determination unit that determines whether the user operates the touch panel with a left hand or a right hand according to a shape of the contact region identified by the region identification unit, a display controller that displays the operation screen on the touch panel so that an arrangement of a display element displayed on the operation screen is changed according to a result of determination by the determination unit, and a print controller that causes a printing unit to perform printing based on an operation on the operation screen.

The present application is based on, and claims priority from JP Application Serial Number 2022-047182, filed Mar. 23, 2022, the disclosure of which is hereby incorporated by reference herein in its entirety.

### BACKGROUND

### 1. Technical Field

The present disclosure relates to an image forming apparatus, a display device, and a control method for the image forming apparatus.

### 2. Related Art

In the related art, as disclosed in JP-A-2013-003619, a known image forming apparatus that includes an arm position detection unit that detects the user's arm and a body position detection unit that detects the user's body determines with which hand, left or right, the user operates the touch panel based on the detection results of these two detection units, and controls the display of the display unit based on the determination result.

The image forming apparatus disclosed in JP-A-2013-003619 requires a plurality of detection units in addition to the touch panel, thereby increasing the size of the apparatus and increasing the manufacturing cost.

### SUMMARY

According to an aspect of the present disclosure, an image forming apparatus includes a touch panel that displays an operation screen, a region identification unit that identifies a contact region that is a region where a finger of a user operating the touch panel touches the touch panel, a determination unit that determines whether the user operates the touch panel with a left hand or a right hand according to a shape of the contact region identified by the region identification unit, a display controller that displays the operation screen on the touch panel so that an arrangement of a display element displayed on the operation screen is changed according to a result of determination by the determination unit, and a print controller that causes a printing unit to perform printing based on an operation on the operation screen.

According to another aspect of the present disclosure, a display device includes a touch panel that displays an operation screen, a region identification unit that identifies a contact region that is a region where a finger of a user operating the touch panel touches the touch panel, a determination unit that determines whether the user operates the touch panel with a left hand or a right hand according to a shape of the contact region identified by the region identification unit, and a display controller that displays the operation screen on the touch panel so that an arrangement of a display element displayed on the operation screen is changed according to a result of determination by the determination unit.

According to still another aspect of the present disclosure, in a method of controlling an image forming apparatus, the method includes the image forming apparatus including a touch panel that displays an operation screen identifying a contact region that is a region where a finger of a user operating the touch panel touches the touch panel, determining whether the user operates the touch panel with a left hand or a right hand according to a shape of the identified contact region, displaying the operation screen on the touch panel so that an arrangement of a display element displayed on the operation screen is changed according to a result of determination on whether the touch panel is operated with the left hand or operated with the right hand, and causing a printing unit to perform printing based on an operation on the operation screen.

### BRIEF DESCRIPTION OF THE DRAWINGS

FIG. 1 is a block diagram showing the hardware configuration of an image forming apparatus.

FIG. 2 is a block diagram showing the functional configuration of the image forming apparatus.

FIG. 3 is a diagram showing the way in which a user operates an operation screen with the right hand.

FIG. 4 is a diagram showing the way in which a user operates an operation screen with the left hand.

FIG. 5 is an explanatory diagram of a contact region when a user operates with the right hand.

FIG. 6 is an explanatory diagram of a contact region when a user operates with the left hand.

FIG. 7 is a diagram showing an example of a home screen.

FIG. 8 is a diagram showing a first right hand operation screen.

FIG. 9 is a diagram showing a first left hand operation screen.

FIG. 10 is a diagram showing a second right hand operation screen.

FIG. 11 is a diagram showing a second left hand operation screen.

FIG. 12 is a diagram showing a third right hand operation screen.

FIG. 13 is a diagram showing a third left hand operation screen.

FIG. 14 is a flowchart showing an operation hand determination process.

FIG. 15 is a flowchart showing an operation screen display process.

FIG. 16 is a diagram showing an example of a dedicated screen.

### DESCRIPTION OF EXEMPLARY EMBODIMENTS

An image forming apparatus, a display device, and a method of controlling the image forming apparatus according to an embodiment will be described below with reference to the accompanying drawings. In some drawings, the directions of the XY coordinate system are used for explanation, but these directions are only for convenience of explanation and do not limit the embodiments in any way. The +X direction of the XY coordinate system indicates the right direction when viewed by the user, and the −X direction indicates the left direction when viewed by the user.

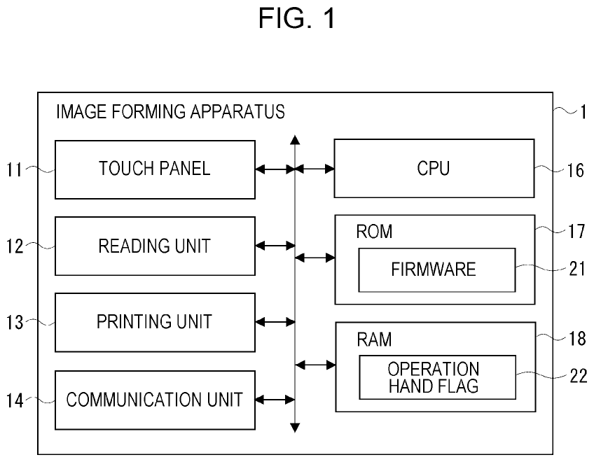

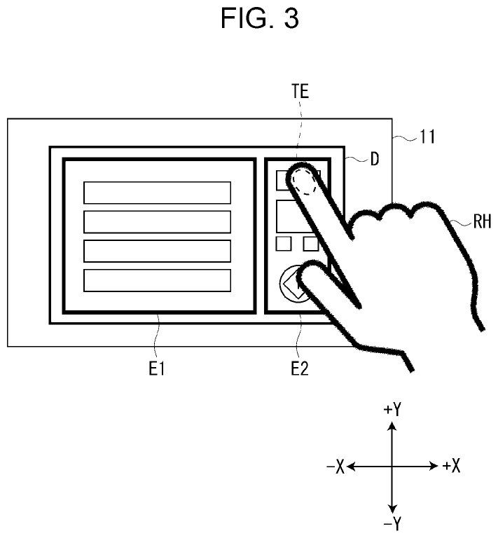

FIG. 1 is a block diagram showing the hardware configuration of an image forming apparatus 1. The image forming apparatus 1 is an example of a “display device”. The image forming apparatus 1 according to the present embodiment includes a touch panel 11, and provides the user with an easy-to-use operation screen D depending on whether the hand of the user who operates the touch panel 11 is the right hand RH or the left hand LH. Specifically, the image forming apparatus 1 according to the present embodiment determines whether the hand of the user who operates the touch panel 11 is the right hand RH or the left hand LH according to the shape of a contact region TE that is a region where the finger of the user touches the touch panel 11 as shown in FIG. 3 or the like. Hereinafter, of the right hand RH and left hand LH, the hand with which the user is operating the touch panel 11 will be referred to as the “operation hand”. In this way, the image forming apparatus 1 can identify the operation hand of the user with a simple configuration without requiring a special component for identifying the operation hand of the user. In the following description, the present embodiment will focus on determination of the operation hand of the user and display control according to the determination result of the operation hand.

As shown in FIG. 1, the image forming apparatus 1 includes, as a hardware configuration, the touch panel 11, a reading unit 12, a printing unit 13, a communication unit 14, a central processing unit (CPU) 16, a read only memory (ROM) 17, and a random access memory (RAM) 18. The image forming apparatus 1 according to the present embodiment is a multifunction machine having a copy function, a printer function, a facsimile (FAX) function, and a scanner function.

As shown in FIG. 3 and the like, the touch panel 11 displays various operation screens D, receives an operation by the user on the various operation screens D, and detects a touch position. That is, the touch panel 11 is used as a display means and an operation means.

The reading unit 12 reads a document. The reading unit 12 is used for the copy function, the FAX function, and the scanner function. The reading method of the reading unit 12 may be a sheet feed method or a flat bed method.

The printing unit 13 performs printing on a print medium such as copy paper. The printing unit 13 is used for the copy function, the printer function, and the FAX function. The printing method of the printing unit 13 may be any type, such as an ink jet method or an electrophotographic method.

The communication unit 14 is connected to a network such as the Internet and communicates with an external device. The communication unit 14 receives print data from the external device, and transmits scan data and a FAX to the external device.

The CPU 16 performs various kinds of control by loading various control programs such as firmware 21 stored in the ROM 17 into the RAM 18 and executing them. A hardware circuit such as an application specific integrated circuit (ASIC) may be used as a processor instead of the CPU 16. Also, the processor may have a configuration in which one or more CPUs and a hardware circuits such as an ASIC operate in cooperation with each other.

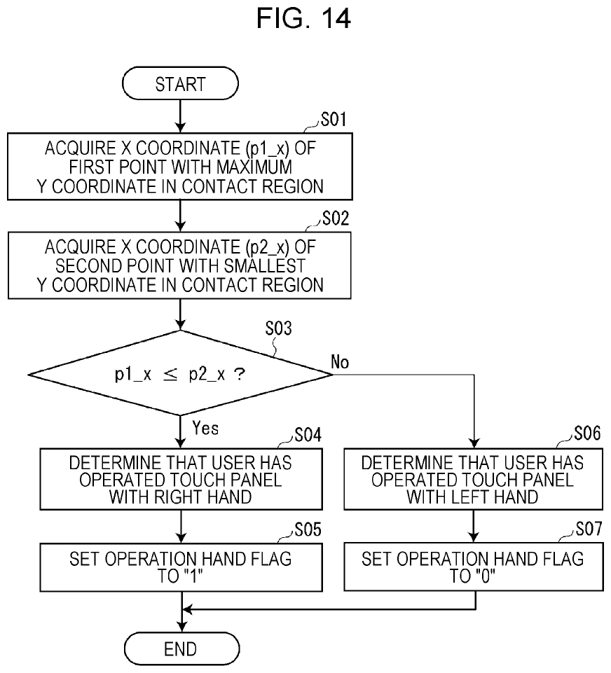

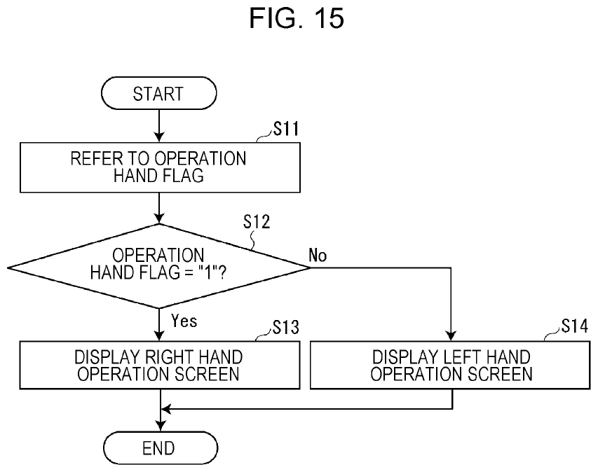

As shown in FIGS. 14 and 15, the ROM 17 is a non-volatile storage medium and stores the firmware 21. The firmware 21 is software for executing various types of processes such as an operation hand determination process and an operation screen display process, which will be described later.

The RAM 18 is a volatile storage medium and has an operation hand flag 22. When the CPU 16 determines that the user operates the touch panel 11 with the right hand RH according to the shape of the contact region TE, the CPU 16 sets the operation hand flag 22 to “1”. On the other hand, when the CPU 16 determines that the user operates the touch panel 11 with the left hand LH according to the shape of the contact region TE, the CPU 16 sets the operation hand flag 22 to “0”.

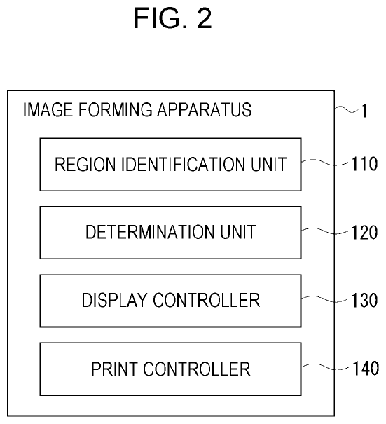

FIG. 2 is a block diagram showing the functional configuration of the image forming apparatus 1. The image forming apparatus 1 includes, as functional configurations, a region identification unit 110, a determination unit 120, a display controller 130, and a print controller 140. These functions are all implemented by the CPU 16 executing the firmware 21.

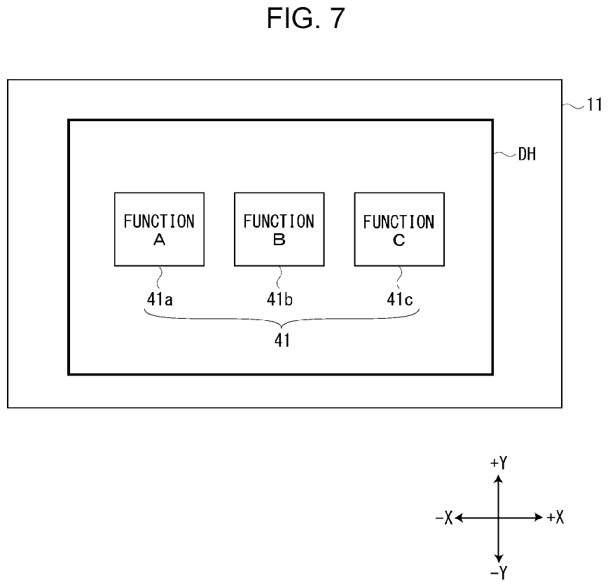

The region identification unit 110 identifies the contact region TE that is a region where the finger of the user operating the touch panel 11 touches the touch panel 11. When the touch panel 11 detects a touch, the region identification unit 110 assumes that the fingertip or finger pad of the hand of the user touches the touch panel 11 and identifies the contact region TE. Further, the region identification unit 110 identifies the contact region TE from the operation by the user on a home screen DH displayed first shown in FIG. 7 among the operation screens D displayed on the touch panel 11. The home screen DH is an example of an “initial operation screen”.

The determination unit 120 determines whether the user operates the touch panel 11 with the left hand LH or the right hand RH, according to the shape of the contact region TE identified by the region identification unit 110.

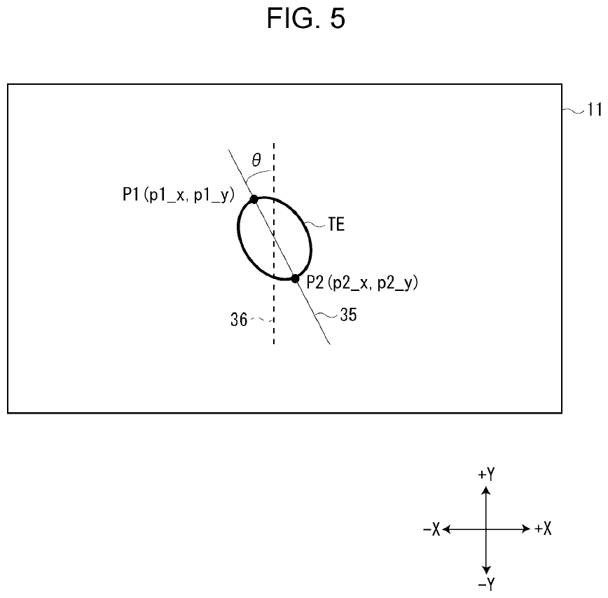

More specifically, when a first point P1 with the maximum Y coordinate in the Y-axis direction of the touch panel 11 is located on the −X side in the X-axis direction of the touch panel 11 relative to a second point P2 with the minimum Y coordinate in the Y-axis direction of the touch panel 11 in the contact region TE, the determination unit 120 determines that the user operates the touch panel 11 with the right hand RH as shown in FIG. 5. That is, when the first point P1 with the maximum Y coordinate is located left of the second point P2 with the minimum Y coordinate when viewed by the user in the contact region TE, the determination unit 120 determines that the user operates the touch panel 11 with the right hand RH.

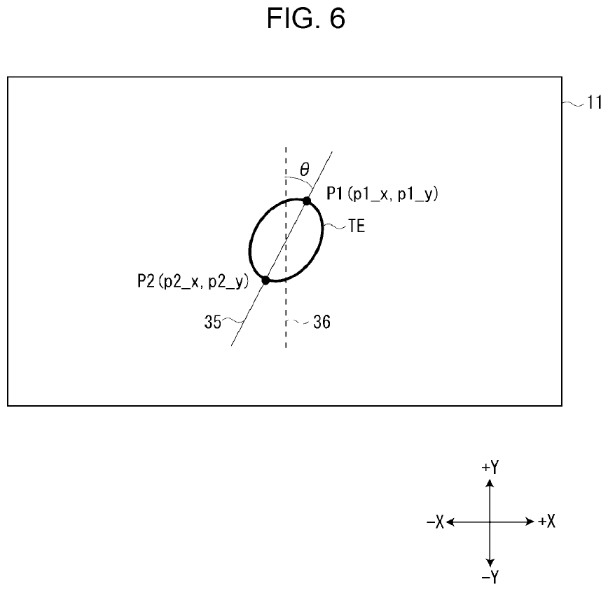

Further, when the first point P1 is located on the +X side in the X-axis direction of the touch panel 11 relative to the second point P2 in the contact region TE, the determination unit 120 determines that the user has touched the touch panel 11 with the left hand LH as shown in FIG. 6. That is, when the first point P1 is located right of the second point P2 when viewed by the user in the contact region TE, the determination unit 120 determines that the user operates the touch panel 11 with the left hand LH.

The display controller 130 displays the operation screen D on the touch panel 11 so that the arrangement of a display elements E displayed on the operation screen D is changed according to the result of determination by the determination unit 120.

More specifically, when the display controller 130 disposes, on the operation screen D, as the display elements E, a first display element E and a second display element E different from the first display element E, the display controller 130 performs the following display control according to the result of determination by the determination unit 120. The display controller 130 displays the operation screen D on the touch panel 11 so that the positional relationship between the first display element E and the second display element E on the operation screen D in the X-axis direction of the touch panel 11, that is, in the left-right direction when viewed by the user is changed according to the result of determination by the determination unit 120.

More specifically, when an operation target region in which the user performs an operation is disposed as the display element E on the operation screen D, the display controller 130 performs the following display control according to the result of determination by the determination unit 120. The display controller 130 displays the operation screen D on the touch panel 11 so that an operation target region on the operation screen D is disposed on the +X side in the X-axis direction of the touch panel 11, that is, on the right side when viewed by the user when the determination unit 120 determines that the touch panel 11 is operated with the right hand RH, compared with when the determination unit 120 determines that the touch panel 11 is operated with the left hand LH.

Note that the display controller 130 changes the arrangement of the display element E on the operation screen D other than the home screen DH among the operation screens D displayed on the touch panel 11 according to the result of determination by the determination unit 120. That is, the region identification unit 110 identifies the contact region TE in the home screen DH, and in the operation screen D displayed after the home screen DH, the display controller 130 performs display control according to the result of determination by the determination unit 120.

The print controller 140 causes the printing unit 13 to perform printing based on the operation on the operation screen D. The image forming apparatus 1 can create printed matter with the print controller 140.

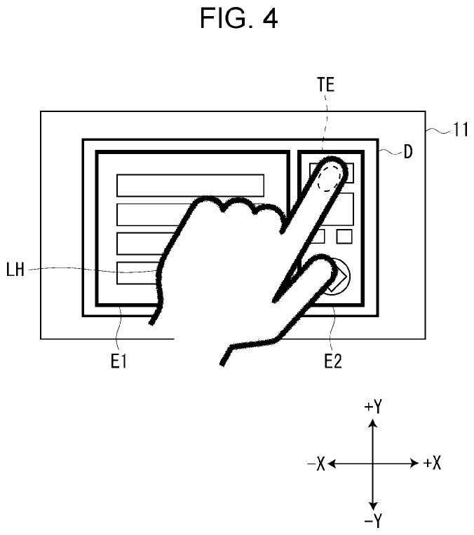

The effect of the image forming apparatus 1 including the display controller 130 will be described with reference to FIGS. 3 and 4. FIG. 3 is a diagram showing the way in which the user operates the operation screen D with the right hand RH. On the other hand, FIG. 4 is a diagram showing the way in which the user operates the operation screen D with the left hand LH. Note that the right hand RH and left hand LH shown in FIGS. 3 and 4, respectively, are illustrated for explanation purposes and are not actually displayed on the touch panel 11.

A first display element E1 and a second display element E2 are disposed on the operation screen D shown in FIGS. 3 and 4. The first display element E1 is an example of a “first display element”. The second display element E2 is an example of a “second display element” and an “operation target region”.

The first display element E1 is, for example, a display region in which setting information is displayed, and the second display element E2 is an operation target region in which the user performs an operation. That is, the second display element E2 is a region that is operated more frequently by the user than the first display element E1. The operation screen D displayed on the touch panel 11 of the image forming apparatus 1 is generally designed so that it can be easily operated with the right hand RH. Therefore, as shown in FIG. 3, when the user operates the second display element E2 with the right hand RH, the user can visually recognize the setting information of the first display element E1.

On the other hand, as shown in FIG. 4, when the user operates the second display element E2 with the left hand LH, the user cannot visually recognize the setting information of the first display element E1 because the user's own left hand LH blocks the line of sight. Therefore, for a user who operates with the left hand LH, it is preferable that the second display element E2, which is the operation target region, be disposed on the −X side relative to the first display element E1, that is, disposed left of the first display element E1.

Therefore, when the determination unit 120 determines that the touch panel 11 is operated with the left hand LH, the display controller 130 disposes the second display element E2, which is the operation target region, on the −X side relative to the first display element E1. In other words, the display controller 130 disposes the second display element E2 on the operation screen D on the −X side, that is, on the left side when viewed by the user when the determination unit 120 determines that the touch panel 11 is operated with the left hand LH, compared with when the determination unit 120 determines that the touch panel 11 is operated with the right hand RH. Thus, a user who performs an operation with the left hand LH can operate the second display element E2 while confirming the setting information displayed on the first display element E1. In addition, the specific arrangement change of the display element E will be described later.

Hereinafter, the operation screen D displayed by the display controller 130 when the determination unit 120 determines that the user operates the touch panel 11 with the right hand RH, that is, the operation screen D displayed when the operation hand flag 22 is “1” is referred to as a “right hand operation screen DR”. On the other hand, the operation screen D displayed by the display controller 130 when the determination unit 120 determines that the user operates the touch panel 11 with the left hand LH, that is, the operation screen D displayed when the operation hand flag 22 is “0” is referred to as a “left hand operation screen DL”.

A method of determining the operation hand by the determination unit 120 will be described with reference to FIGS. 5 and 6. FIG. 5 is an explanatory diagram of the contact region TE when the user operates with the right hand RH. On the other hand, FIG. 6 is an explanatory diagram of the contact region TE when the user operates with the left hand LH. In FIGS. 5 and 6, the first point P1 is the point with the maximum Y coordinate in the contact region TE, and the second point P2 is the point with the minimum Y coordinate in the contact region TE.

When the coordinates of the first point P1 is (p1_x, p1_y) and the coordinates of the second point P2 is (p2_x, p2_y), the determination unit 120 determines whether the user operates the touch panel 11 with the left hand LH or with the right hand RH based on the X coordinate (p1_x) of the first point P1 and the X coordinate (p2_x) of the second point P2.

More specifically, as shown in FIG. 5, the determination unit 120 determines that the user operates the touch panel 11 with the right hand RH when “p1_x<p2_x”. Further, as shown in FIG. 6, the determination unit 120 determines that the user operates the touch panel 11 with the left hand LH when “p1_x>p2_x”.

Note that the determination unit 120 may determine the operation hand as follows instead of comparing the value of “p1_x” with the value of “p2_x” to determine the operation hand. For example, as shown in FIG. 5, the determination unit 120 may determine that the user operates the touch panel 11 with the right hand RH when the rotation angle θ of a straight line 35 connecting the first point P1 and the second point P2 with respect to a reference line 36 parallel to the Y-axis is 0°<θ<90°. The rotation angle θ has a positive value for counterclockwise rotation and a negative value for clockwise rotation. In FIGS. 5 and 6, the straight line 35 is indicated by a solid line, and the reference line 36 is indicated by a broken line. On the other hand, as shown in FIG. 6, the determination unit 120 may determine that the user operates the touch panel 11 with the left hand LH when the rotation angle θ of the straight line 35 connecting the first point P1 and the second point P2 with respect to the reference line 36 parallel to the Y-axis is “−90°<θ<0°”.

In the present embodiment, when “p1_x=p2_x”, that is, when the rotation angle θ of the straight line 35 with respect to the reference line 36 is “0°”, the determination unit 120 determines that the user operates the touch panel 11 with the right hand RH. In other words, the determination unit 120 determines that the user operates the touch panel 11 with the right hand RH when determining that “p1_x p2_x”, and determines that the user operates the touch panel 11 with the left hand LH when determining that “p1_x>p2_x”. Further, when the rotation angle θ is “0°”, a message requesting the user to re-touch the contact region TE may be displayed on the touch panel 11, and the operation hand of the user may be determined from the re-touch identification result.

Display control by the display controller 130 will be described with a specific example of the operation screen D with reference to FIGS. 7 to 13. FIG. 7 is a diagram showing an example of the home screen DH. The home screen DH is a screen displayed first among the operation screens D displayed on the touch panel 11.

A FUNCTION A button 41a for selecting “FUNCTION A”, a FUNCTION B button 41b for selecting “FUNCTION B”, and a FUNCTION C button 41c for selecting “FUNCTION C” are displayed in the home screen DH shown in FIG. 7. “FUNCTION A”, “FUNCTION B”, and “FUNCTION C” are functions provided in the image forming apparatus 1, and are, for example, a copy function, a printer function, and a FAX function, respectively. The user touches one of the function buttons 41 on the home screen DH. The region identification unit 110 identifies the contact region TE by detecting the user's touch operation on the home screen DH using the touch panel 11.

When the function button 41 is touched, the display controller 130 displays, on the touch panel 11, an execution screen for executing each function. Further, when the user performs a predetermined operation on the execution screen of each function, the display controller 130 displays a setting screen for setting each function on the touch panel 11. Further, when the user performs a predetermined operation on the setting screen of each function, the display controller 130 displays, on the touch panel 11, a setting information display screen that displays a list of setting information set on the setting screen.

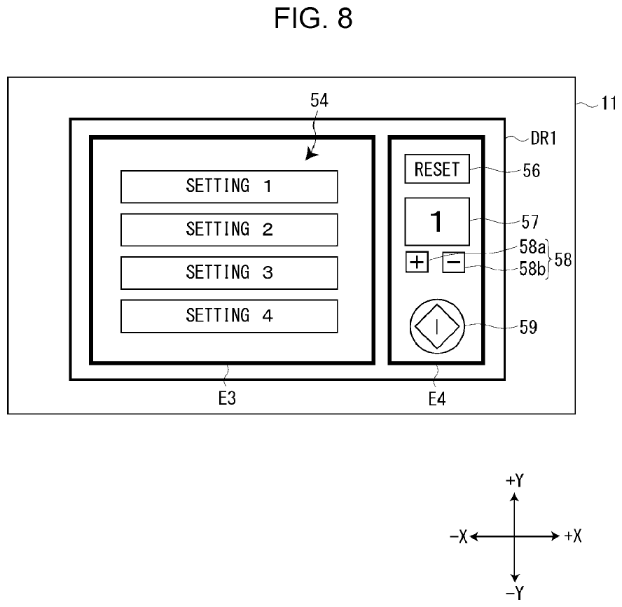

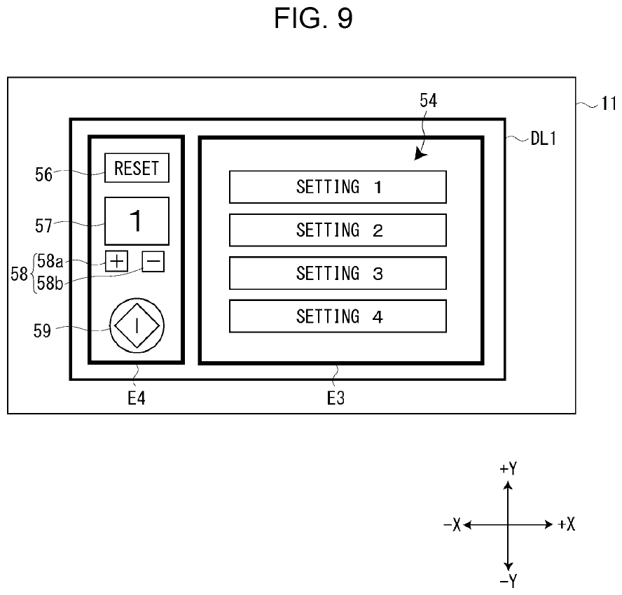

FIG. 8 is a diagram showing a first right hand operation screen DR1. FIG. 9 is a diagram showing a first left hand operation screen DL1. The first right hand operation screen DR1 and the first left hand operation screen DL1 are copy function execution screens displayed when the function button 41 for selecting the copy function is touched on the home screen DH.

A third display element E3 and a fourth display element E4 are disposed on each of the first right hand operation screen DR1 and the first left hand operation screen DL1. The third display element E3 is an example of the “first display element”. The fourth display element E4 is an example of the “second display element” and the “operation target region”. The third display element E3 is a region in which copy setting information 54 related to the copy function is displayed. The copy setting information 54 includes, for example, information about color setting or monochrome setting, information indicating enlargement ratio or reduction ratio, information indicating print density, and information indicating image quality.

The fourth display element E4 is a region where the user performs various operations related to the copy function. A reset button 56, a number of copies display region 57, a number of copies change button 58, and a copy start button 59 are displayed on the fourth display element E4. The reset button 56 is a button for resetting the setting of the copy function. The number of copies display region 57 is a region in which the number of copies is displayed. The number of copies change button 58 is a button for changing the number of copies, and includes a plus button 58a for increasing the number of copies and a minus button 58b for decreasing the number of copies. The copy start button 59 is a button for executing copying. When the copy start button 59 is touched, the image forming apparatus 1 executing copying for the number of copies displayed in the number of copies display region 57 according to the copy setting information 54 displayed in the third display element E3.

As shown in FIGS. 8 and 9, the display controller 130 changes the positional relationship in the X-axis direction between the third display element E3 and the fourth display element E4 for the first right hand operation screen DR1 and the first left hand operation screen DL1. For example, the display controller 130 disposes the fourth display element E4, which is the operation target region, on the +X side of the screen in the first right hand operation screen DR1 while disposing the fourth display element E4 on the −X side of the screen in the first left hand operation screen DL1. In other words, the display controller 130 disposes the third display element E3 and the fourth display element E4 so that the fourth display element E4, which is the operation target region, is disposed on the −X side, that is, on the left side when viewed by the user in the first left hand operation screen DL1, compared with in the first right hand operation screen DR1.

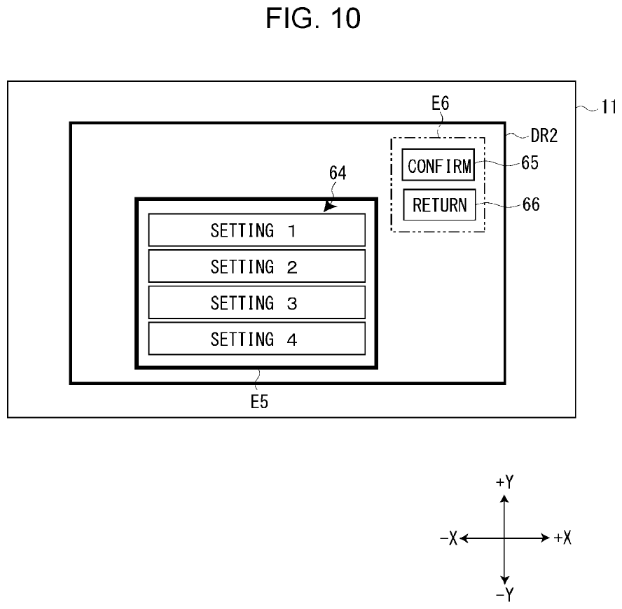

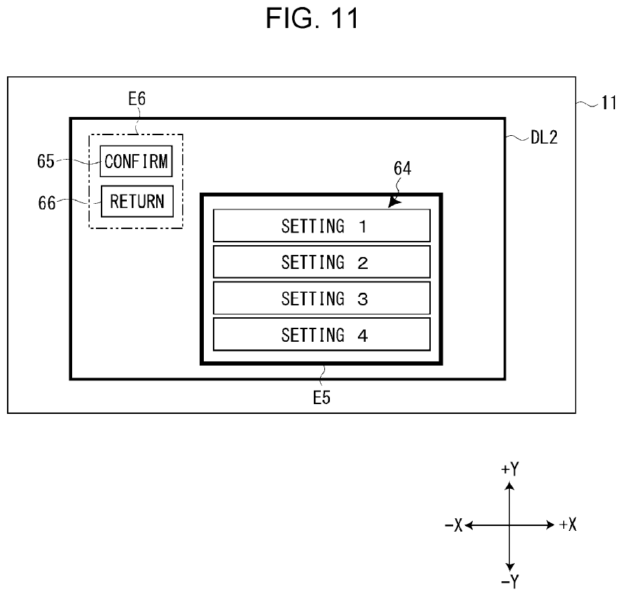

FIG. 10 is a diagram showing a second right hand operation screen DR2. FIG. 11 is a diagram showing a second left hand operation screen DL2. The second right hand operation screen DR2 and the second left hand operation screen DL2 are setting information display screens of the printer function. When the function button 41 for selecting the printer function is touched on the home screen DH, the display controller 130 displays a printer function execution screen (not shown). Further, when a predetermined operation is performed on the printer function execution screen, the display controller 130 displays a printer function setting screen (not shown), and when a predetermined operation is performed on the printer function setting screen, the display controller 130 displays the setting information display screen of the printer function.

A fifth display element E5 and a sixth display element E6 are disposed on each of the second right hand operation screen DR2 and the second left hand operation screen DL2. The fifth display element E5 is an example of the “first display element”. The sixth display element E6 is an example of the “second display element” and the “operation target region”. In FIGS. 10 and 11, the imaginary line frame of the sixth display element E6 indicated by a chain double-dashed line indicates the region of the sixth display element E6, and is not actually displayed on the operation screen D.

The fifth display element E5 is a region in which printer setting information 64 regarding printer functions is displayed. The printer setting information 64 includes, for example, information about printing quality, information about paper, and information indicating the number of copies to be printed.

The sixth display element E6 is a region where the user performs a confirmation operation or a return operation. A first confirm button 65 and a first return button 66 are displayed on the sixth display element E6. When the first confirm button 65 is touched, the image forming apparatus 1 confirms the printer setting information 64 displayed in the fifth display element E5, and displays a printer function execution screen (not shown). When the first return button 66 is touched, the image forming apparatus 1 displays a printer function setting screen (not shown) without confirming the printer setting information 64 displayed in the fifth display element E5.

As shown in FIGS. 10 and 11, the display controller 130 changes the positional relationship in the X-axis direction between the fifth display element E5 and the sixth display element E6 for the second right hand operation screen DR2 and the second left hand operation screen DL2. For example, the display controller 130 disposes the sixth display element E6, which is the operation target region, on the +X side of the screen in the second right hand operation screen DR2 while disposing the sixth display element E6 on the −X side of the screen in the second left hand operation screen DL2. In other words, the display controller 130 disposes the fifth display element E5 and the sixth display element E6 so that the sixth display element E6, which is the operation target region, is disposed on the −X side, that is, on the left side when viewed by the user in the second left hand operation screen DL2, compared with in the second right hand operation screen DR2.

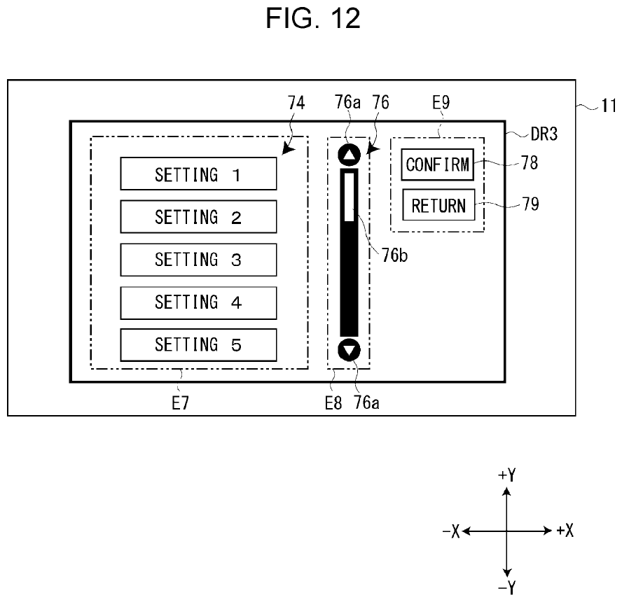

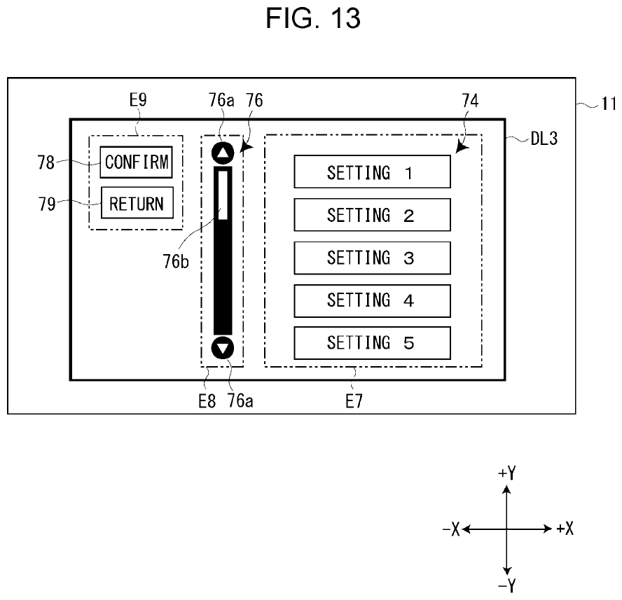

FIG. 12 shows a third right hand operation screen DR3. FIG. 13 shows a third left hand operation screen DL3. The third right hand operation screen DR3 and the third left hand operation screen DL3 are setting information display screens of the FAX function. When the function button 41 for selecting the FAX function is touched on the home screen DH, the display controller 130 displays a FAX function execution screen (not shown). Further, when a predetermined operation is performed on the FAX function execution screen, the display controller 130 displays a FAX function setting screen (not shown), and when a predetermined operation is performed on the FAX function setting screen, the display controller 130 displays the setting information display screen of the FAX function.

A seventh display element E7, an eighth display element E8, and a ninth display element E9 are disposed on each of the third right hand operation screen DR3 and the third left hand operation screen DL3. The seventh display element E7 is an example of the “first display element”. Each of the eighth display element E8 and the ninth display element E9 is an example of the “second display element” and the “operation target region”. In FIGS. 12 and 13, the imaginary line frame indicated by the chain double-dashed line indicates the region of each display element E, and is not actually displayed on the operation screen D.

The seventh display element E7 is a region in which FAX setting information 74 regarding the FAX function is displayed. The FAX setting information 74 includes, for example, information about a FAX transmission destination, information indicating reading density, information indicating resolution, and the like.

The eighth display element E8 is a region where the user performs a scrolling operation on the seventh display element E7. A scroll bar 76 is displayed in the eighth display element E8. When an arrow button 76a or a knob 76b of the scroll bar 76 is operated, the display controller 130 scrolls the display of the seventh display element E7 according to the operation.

The ninth display element E9 is a region where the user performs a confirmation operation or a return operation. A second confirm button 78 and a second return button 79 are displayed on the eighth display element E8. When the second confirm button 78 is touched, the image forming apparatus 1 confirms the FAX setting information 74 displayed in the seventh display element E7, and displays a FAX function execution screen (not shown). When the second return button 79 is touched, the image forming apparatus 1 displays a FAX function setting screen (not shown) without confirming the FAX setting information 74 displayed in the seventh display element E7.

As shown in FIGS. 12 and 13, the display controller 130 changes the positional relationship in the X-axis direction between the seventh display element E7, the eighth display element E8, and the ninth display element E9 for the third right hand operation screen DR3 and the third left hand operation screen DL3. For example, the display controller 130 disposes the seventh display element E7, the eighth display element E8 and the ninth display element E9 so that the arrangements of the display element E of the third right hand operation screen DR3 and the third left hand operation screen DL3 are bilaterally symmetric with each other when viewed by the user.

More specifically, the display controller 130 disposes the eighth display element E8 and the ninth display element E9, each of which is the operation target region, on the +X side of the screen in the third right hand operation screen DR3 while disposing the eighth display element E8 and the ninth display element E9 on the −X side of the screen in the third left hand operation screen DL3. In other words, the display controller 130 disposes the eighth display element E8 and the ninth display element E9 so that the eighth display element E8 and the ninth display element E9, each of which is the operation target region, are disposed on the −X side, that is, on the left side when viewed by the user in the third left hand operation screen DL3, compared with in the third right hand operation screen DR3.

The operation hand determination process executed by the image forming apparatus 1 will be described with reference to the flowchart of FIG. 14. The operation hand determination process indicates a process by the determination unit 120, and is an example of the “method of controlling the image forming apparatus”. The operation hand determination process is started when the home screen DH is touched and the contact region TE is identified by the region identification unit 110.

In step S01, the image forming apparatus 1 acquires the X coordinate (p1_x) of the first point P1 having the maximum Y coordinate in the contact region TE identified by the region identification unit 110.

In step S02, the image forming apparatus 1 acquires the X coordinate (p2_x) of the second point P2 with the minimum Y coordinate in the contact region TE identified by the region identification unit 110.

In step S03, the image forming apparatus 1 determines whether “p1_x p2_x”. When the image forming apparatus 1 determines that “p1_x p2_x”, the process proceeds to step S04. When the image forming apparatus 1 determines that “p1_x p2_x” does not hold, that is, when the image forming apparatus 1 determines that “p1_x>p2_x”, the process proceeds to step S06.

In step S04, the image forming apparatus 1 determines that the user operates the touch panel 11 with the right hand RH.

In step S05, the image forming apparatus 1 sets the operation hand flag 22 to “1”.

In step S06, the image forming apparatus 1 determines that the user operates the touch panel 11 with the left hand LH.

In step S07, the image forming apparatus 1 sets the operation hand flag 22 to “0”.

The operation screen display process executed by the image forming apparatus 1 will be described with reference to the flowchart of FIG. 15. The operation screen display process indicates a process by the display controller 130 and is an example of the “method of controlling the image forming apparatus”. The operation screen display process is started when an operation to open another operation screen D is performed on the home screen DH or the operation screen D displayed after the home screen DH.

In step S11, the image forming apparatus 1 refers to the operation hand flag 22.

In step S12, the image forming apparatus 1 determines whether the operation hand flag 22 is set to “1”. When the image forming apparatus 1 determines that the operation hand flag 22 is set to “1”, the process proceeds to step S13. When the image forming apparatus 1 determines that the operation hand flag 22 is not set to “1”, that is, that the operation hand flag 22 is set to “0”, the process proceeds to step S14.

In step S13, the image forming apparatus 1 displays the right hand operation screen DR on the touch panel 11.

In step S14, the image forming apparatus 1 displays the left hand operation screen DL on the touch panel 11.

As described above, the image forming apparatus 1 according to the present embodiment determines whether the user touches the touch panel 11 with the left hand LH or the right hand RH according to the shape of the contact region TE where the finger of the user touches the touch panel 11. As a result, the image forming apparatus 1 can determinate the operation hand of the user without requiring a special component for determining the operation hand, and provide the user with the easy-to-use operation screen D according to the determined operation hand. Further, since the image forming apparatus 1 identifies the contact region TE from the user's normal operation, it is possible to determine the operation hand without imposing a burden on the user and without lowering productivity.

Further, in the contact region TE, the image forming apparatus 1 can easily determine the operation hand of the user by acquiring the X coordinate of the first point P1 with the maximum Y coordinate in the Y-axis direction of the touch panel 11 and the X coordinate of the second point P2 with the minimum Y coordinate in the Y-axis direction of the touch panel 11, and simply comparing a value of the X coordinate of the first point P1 with a value of the X coordinate of the second point P2.

In addition, the image forming apparatus 1 changes the positional relationship between the first display element E1 and the second display element E2 on the operation screen D in the left-right direction when viewed by the user according to the operation hand of the user, so that it is possible to provide the user with the easy-to-use operation screen D without significantly changing the visual appearance of the right hand operation screen DR and the left hand operation screen DL.

Further, the image forming apparatus 1 disposes the operation target region so that the operation target region on the operation screen D is located on the right side when viewed by the user when the user operates the touch panel with the right hand RH, compared with when the user operates the touch panel with the left hand LH, so that it is possible to provide the user with the easy-to-use operation screen D.

Further, the image forming apparatus 1 can determine the operation hand of the user based on the operation by the user on the home screen DH, and can provide the user with the operation screen D suitable for the operation hand for the operation screens D displayed after the home screen DH.

It should be noted that the following modifications can be used regardless of the above embodiments.

### FIRST MODIFICATION

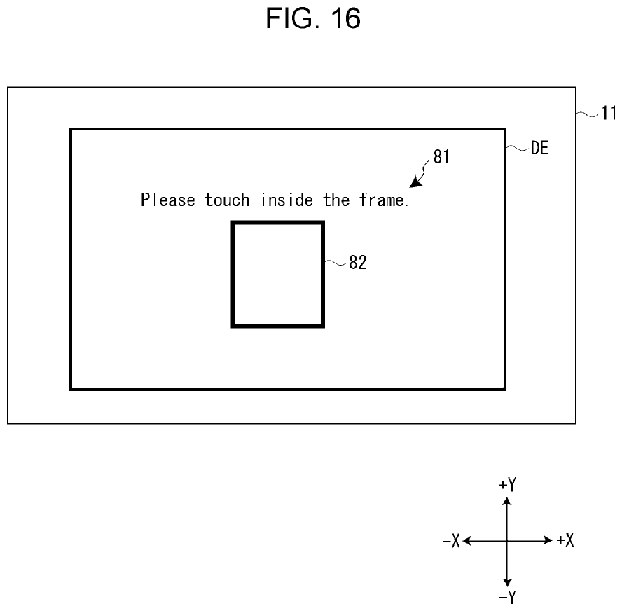

In the above embodiment, the region identification unit 110 identifies the contact region TE based on the operation by the user on the home screen DH, but may identify the contact region TE based on the operation by the user on a dedicated screen DE shown in FIG. 16. The dedicated screen DE is an example of the “initial operation screen”.

FIG. 16 is a diagram showing an example of the dedicated screen DE. A message 81 and a touch frame 82 are displayed on the dedicated screen DE. The message 81 has a content that prompts the user to touch a place within the touch frame 82. The touch frame 82 is a rectangular frame and is disposed substantially in the center of the dedicated screen DE in the X-axis direction. In this modification, the region identification unit 110 identifies the contact region TE based on the user's touch operation on the inside of the touch frame 82.

### SECOND MODIFICATION

In order for the image forming apparatus 1 to accurately determine the operation hand of the user, it is preferable that the touch panel 11 is operated while the user is facing the touch panel 11. Therefore, in order to narrow the viewing angle of the touch panel 11, the image forming apparatus 1 may include a privacy filter for preventing peeping on the touch panel 11. Further, the image forming apparatus 1 may include, as the display of the touch panel 11, a display with a narrow viewing angle, such as a liquid crystal display. In addition, the image forming apparatus 1 may further narrow the viewing angle by controlling the orientation of the liquid crystal molecules of the liquid crystal display to achieve a state of enhanced privacy.

### THIRD MODIFICATION

The image forming apparatus 1 may identify the contact region TE a plurality of times, and determine the operation hand of the user based on the results of the plurality of times of identification. For example, the determination unit 120 calculates the average value of the rotation angles θ of the straight line 35 connecting the first point P1 and the second point P2 with respect to the reference line 36 parallel to the Y-axis from the results of identifying the contact region TE a plurality of times, and when the average value of the rotation angles θ is “0°<θ<90°”, the determination unit 120 determines that the user operates the touch panel 11 with the right hand RH as shown in FIG. 5. Further, when the average value of the rotation angles θ is “−90°<θ<0°”, the determination unit 120 determines that the user operates the touch panel 11 with the left hand LH as shown in FIG. 6. Further, when the average value of the rotation angles θ is “0°”, it may be determined that the user operates the touch panel 11 with the right hand RH, or a message stating that the user is requested to re-touch the contact region TE one or more times may be displayed on the touch panel 11, and the operation hand of the user may be determined based on the re-touch identification result.

### FOURTH MODIFICATION

In the examples shown in FIGS. 8 to 13, the display controller 130 changes the display so that the arrangements of the display element E of the right hand operation screen DR and the left hand operation screen DL are bilaterally symmetric when viewed by the user, but they do not necessarily have to be symmetric.

In addition, the display controller 130 may display the operation screen D on the touch panel 11 so that not only the positional relationship of the plurality of display elements E on the operation screen D in the X-axis direction, but also the positional relationship of the plurality of display elements E on the operation screen D in the Y-axis direction that intersects the X-axis according to the result of determination by the determination unit 120.

In addition, in the examples shown in FIGS. 8 to 13, the display element E for displaying the setting information is shown as the “first display element”, but the “first display element” may be a region for not only displaying the setting information but also performing an operation.

Moreover, the display controller 130 does not necessarily have to arrange the plurality of display elements E on the operation screen D. For example, the display controller 130 may dispose one operation target region as the display element E on the operation screen D.

### FIFTH MODIFICATION

Further, the determination unit 120 may employ the following method as a method of determining the operation hand of the user. As a premise, the image forming apparatus 1 stores right hand region data indicating the shape of the contact region TE when the touch panel 11 is touched with the right hand RH and left hand region data indicating the shape of the contact region TE when the touch panel 11 is touched with the left hand LH in the ROM 17 or the like. The determination unit 120 collates the shape of the contact region TE identified by region identification unit 110 with the right hand region data and the left hand region data. When a degree of similarity between the shape of the identified contact region TE and the right hand region data is greater than a degree of similarity between the shape of the identified contact region TE and the left hand region data as a result of the collation, the determination unit 120 determines that the touch panel 11 is operated with the right hand RH. Further, when a degree of similarity between the shape of the identified contact region TE and the right hand region data is smaller than a degree of similarity between the shape of the identified contact region TE and the left hand region data, the determination unit 120 determines that the touch panel 11 is operated with the left hand LH.

Further, the image forming apparatus 1 may store a region data group including a plurality of types of right hand region data and a plurality of types of left hand region data. In this case, when the region data having the highest degree of similarity to the shape of the identified contact region TE in the region data group is the right hand region data, the determination unit 120 determines that the touch panel 11 is operated with the right hand RH. Further, when the region data having the highest degree of similarity to the shape of the identified contact region TE in the region data group is the left hand region data, the determination unit 120 determines that the touch panel 11 is operated with the left hand LH.

### SIXTH MODIFICATION

In the above embodiments, a multifunction machine is described as an example of the “image forming apparatus”, but the above embodiments can also be applied to devices other than the multifunction machine. For example, the “image forming apparatus” may be a device including the touch panel 11 and the printing unit 13, such as a copier, a printer, or a FAX device.

In addition to these devices, the above-described embodiments may be applied to devices having the touch panel 11. A “display device” refers to a device that includes the touch panel 11 and performs display control of the touch panel 11. In addition, appropriate modifications can be made without departing from the gist of the disclosure.

### APPENDIX

The image forming apparatus, the display device, and the control method of the image forming apparatus will be additionally described below. The image forming apparatus 1 includes the touch panel 11 that displays the operation screen D, the region identification unit 110 that identifies the contact region TE that is a region where a finger of a user operating the touch panel 11 touches the touch panel 11, the determination unit 120 that determines whether the user operates the touch panel 11 with the left hand LH or the right hand RH according to a shape of the contact region TE identified by the region identification unit 110, the display controller 130 that displays the operation screen D on the touch panel 11 so that an arrangement of the display element E displayed on the operation screen D is changed according to a result of determination by the determination unit 120, and the print controller 140 that causes the printing unit 13 to perform printing based on an operation on the operation screen D.

The display device 1 includes the touch panel 11 that displays the operation screen D, the region identification unit 110 that identifies the contact region TE that is a region where a finger of a user operating the touch panel 11 touches the touch panel 11, the determination unit 120 that determines whether the user operates the touch panel 11 with the left hand LH or the right hand RH according to a shape of the contact region TE identified by the region identification unit 110, and the display controller 130 that displays the operation screen D on the touch panel 11 so that an arrangement of the display element E displayed on the operation screen D is changed according to a result of determination by the determination unit 120.

In the method of controlling the image forming apparatus 1, the method includes the image forming apparatus 1 including the touch panel 11 that displays the operation screen D identifying the contact region TE that is a region where a finger of a user operating the touch panel 11 touches the touch panel 11, determining whether the user operates the touch panel 11 with the left hand LH or the right hand RH according to a shape of the identified contact region TE, displaying the operation screen D on the touch panel 11 so that an arrangement of the display element E displayed on the operation screen D is changed according to a result of determination on whether the touch panel 11 is operated with the left hand LH or operated with the right hand RH, and causing the printing unit 13 to perform printing based on an operation on the operation screen D.

According to this configuration, the image forming apparatus 1 determines whether the user operates the touch panel 11 with the left hand LH or the right hand RH according to the shape of the contact region TE where the finger of the user touches the touch panel 11. As a result, the image forming apparatus 1 can determinate the operation hand of the user without requiring a special component for determining the operation hand, and provide the user with the easy-to-use operation screen D according to the determined operation hand. Further, it is determined whether the operation is performed with the left hand LH or with the right hand RH each time a series of operations on the touch panel 11 are performed by the user. As a result, it is possible to provide the user with the easy-to-use operation screen D even when the user operates the touch panel 11 with a non-dominant hand, such as when the user operates the touch panel 11 with the left hand LH that is not the dominant hand while holding something with the right hand RH that is the dominant hand.

In the image forming apparatus 1 described above, it is preferable that when the first point P1 with the maximum Y coordinate in the Y-axis direction of the touch panel 11 is located on the +X side in the X-axis direction of the touch panel 11 relative to the second point P2 with the minimum Y coordinate in the Y-axis direction of the touch panel 11 in the contact region TE, the determination unit 120 determine that the user operates the touch panel 11 with the left hand LH, and when the first point P1 is located on the −X side in the X-axis direction of the touch panel 11 relative to the second point P2, the determination unit 120 determine that the user operates the touch panel 11 with the right hand RH.

According to this configuration, the image forming apparatus 1 can determine the operation hand of the user by a simple method based on the first point P1 with the maximum Y coordinate in the Y-axis direction of the touch panel 11 and the second point P2 with the minimum Y coordinate in the Y-axis direction of the touch panel 11 in the contact region TE.

In the image forming apparatus 1 described above, it is preferable that the display controller 130 dispose, as the display elements E, the first display element E and the second display element E different from the first display element E on the operation screen D, and display the operation screen D on the touch panel 11 so that the first display element E and the second display element E on the operation screen D have a different positional relationship in the X-axis direction of the touch panel 11 according to the result of determination by the determination unit 120.

According to this configuration, the image forming apparatus 1 can change the positional relationship between the first display element E and the second display element E on the operation screen D in the X-axis direction of the touch panel 11 according to the operation hand of the user.

In the image forming apparatus 1 described above, it is preferable that the display controller 130 dispose, as the display element E, an operation target region in which the user performs an operation on the operation screen D, and display the operation screen D on the touch panel 11 so that the operation target region on the operation screen D is disposed on the +X side in the X-axis direction of the touch panel 11 when the determination unit 120 determines that the touch panel 11 is operated with the right hand RH, compared with when the determination unit 120 determines that the touch panel 11 is operated with the left hand LH.

According to this configuration, the image forming apparatus 1 can dispose the operation target region so that the operation target region on the operation screen D is disposed on the +X side in the X-axis direction of the touch panel 11 when the user operates the touch panel with the right hand RH, compared with when the user operates the touch panel with the left hand LH.

In the image forming apparatus 1 described above, it is preferable that the region identification unit 110 identify the contact region TE from the operation by the user on the initial operation screen displayed first among the operation screens D displayed on the touch panel 11, and the display controller 130 change the arrangement of the display elements E according to the result of determination by the determination unit 120 for the operation screens D other than the initial operation screen.

According to this configuration, the image forming apparatus 1 can determine the operation hand of the user based on the operation by the user on the initial operation screen, and can perform display that is suitable for the operation hand of the user on the operation screen D displayed after the initial operation screen.

What is claimed is:

1. An image forming apparatus comprising:
a touch panel that displays an operation screen;
a region identification unit that identifies a contact region that is a region where a finger of a user operating the touch panel touches the touch panel;
a determination unit that determines whether the user operates the touch panel with a left hand or a right hand according to a shape of the contact region identified by the region identification unit;
a display controller that displays the operation screen on the touch panel so that an arrangement of a display element displayed on the operation screen is changed according to a result of determination by the determination unit; and
a print controller that causes a printing unit to perform printing based on an operation on the operation screen.

2. The image forming apparatus according to claim 1, wherein
when a first point with a maximum Y coordinate in a Y-axis direction of the touch panel is located on a +X side in an X-axis direction of the touch panel relative to a second point with a minimum Y coordinate in the Y-axis direction of the touch panel in the contact region,
the determination unit
determines that the user operates the touch panel with the left hand, and when the first point is located on a −X side in the X-axis direction of the touch panel relative to the second point, the determination unit determines that the user operates the touch panel with the right hand.

3. The image forming apparatus according to claim 1, wherein
the display controller
disposes, on the operation screen, as the display elements, a first display element and a second display element different from the first display element, and
displays the operation screen on the touch panel so that the first display element and the second display element on the operation screen have a different positional relationship in the X-axis direction of the touch panel according to a result of determination by the determination unit.

4. The image forming apparatus according to claim 1, wherein
the display controller
disposes, on the operation screen, as the display element, an operation target region in which the user performs an operation, and
displays the operation screen on the touch panel so that the operation target region on the operation screen is disposed on the +X side in the X-axis direction of the touch panel when the determination unit determines that the touch panel is operated with the right hand, compared with when the determination unit determines that the touch panel is operated with the left hand.

5. The image forming apparatus according to claim 1, wherein
the region identification unit
identifies the contact region from an operation by the user on an initial operation screen displayed first among the operation screens displayed on the touch panel, and wherein
the display controller
changes an arrangement of the display element according to a result of determination by the determination unit for the operation screens other than the initial operation screen.

6. A display device comprising:
a touch panel that displays an operation screen;
a region identification unit that identifies a contact region that is a region where a finger of a user operating the touch panel touches the touch panel;
a determination unit that determines whether the user operates the touch panel with a left hand or a right hand according to a shape of the contact region identified by the region identification unit; and
a display controller that displays the operation screen on the touch panel so that an arrangement of a display element displayed on the operation screen is changed according to a result of determination by the determination unit.

7. A method of controlling an image forming apparatus, the method comprising:
the image forming apparatus including a touch panel that displays an operation screen
identifying a contact region that is a region where a finger of a user operating the touch panel touches the touch panel;
determining whether the user operates the touch panel with a left hand or a right hand according to a shape of the identified contact region;
displaying the operation screen on the touch panel so that an arrangement of a display element displayed on the operation screen is changed according to a result of determination on whether the touch panel is operated with the left hand or operated with the right hand; and
causing a printing unit to perform printing based on an operation on the operation screen.
